(19) United States
(12) Patent Application Publication
(10) Pub. No.: US 2025/0242296 A1
(43) Pub. Date: Jul. 31, 2025

(54) Low Temperature Hydrogen Sulfide Removal Systems with Hydriodic Acid and Iodine Mixtures

(71) Applicant: Thiozen Inc., Beverly, MA (US)

(72) Inventors: Ryan Joseph Gillis, Belmont, MA (US); Rachid Taha, Dublin, OH (US)

(21) Appl. No.: 19/041,335

(22) Filed: Jan. 30, 2025

Related U.S. Application Data
(60) Provisional application No. 63/627,212, filed on Jan. 31, 2024.

(51) Int. Cl. B01D 53/14; B01D 46/00; B01D 53/18; B01D 53/52; B01D 53/86

(52) U.S. Cl. CPC B01D 53/1468; B01D 46/00; B01D 53/1425; B01D 53/18; B01D 53/52; B01D 53/8612; B01D 53/869; B01D 2257/304

(57) ABSTRACT

A method is provided for removing hydrogen sulfide from a gas or liquid stream containing hydrogen sulfide, the method comprises reacting the hydrogen sulfide in the gas or liquid stream in a reactor containing a mixture of iodine, water and hydriodic acid, under low temperature conditions, to thereby remove the hydrogen sulfide; and then regenerating the iodine in the liquid phase under conditions below the boiling point or vaporization of the mixture.

### RELATED APPLICATION(S)

This application claims the benefit of U.S. Provisional Application No. 63/627,212, filed on Jan. 31, 2024. The entire teachings of the above application(s) are incorporated herein by reference.

### BACKGROUND

Hydrogen iodide is a colorless vapor that readily dissolves in aqueous solutions to create a transparent solution of hydriodic acid. This acid is completely ionized in water forming iodide and hydronium ions. The mixture has an azeotrope at approximately 57 wgt % hydrogen iodide. Hydriodic acid is unstable and will spontaneously decompose into hydrogen gas and iodine. Hydriodic acid when exposed to oxygen will more quickly decompose into water and iodine.

Iodine when exposed to hydrogen sulfide will react to form hydriodic acid and sulfur, either in the form of elemental sulfur or sulfur dioxide depending on the concentration of the reactants.

The removal of hydrogen sulfide from gas streams and the production of hydrogen gas are both valuable industrial activities across a variety of industries including oil and gas, pulp and paper manufacturing, and waste processing.

### SUMMARY

The present disclosure describes hydrogen sulfide removal systems that use the reactivity of iodine with hydrogen sulfide to remove hydrogen sulfide from a gas or liquid stream and the instability of the hydriodic acid product of this reaction to regenerate the iodine under thermal, photonic, catalyzed, or other conditions, as discussed below.

In one embodiment, a method is provided for removing hydrogen sulfide from a gas or liquid stream containing hydrogen sulfide, the method comprises reacting the hydrogen sulfide in the gas or liquid stream in a reactor containing a mixture of iodine, water and hydriodic acid, under low temperature conditions (e.g., under conditions below the boiling point or vaporization of the mixture), to thereby remove the hydrogen sulfide; and then regenerating the iodine in the liquid phase under conditions below the boiling point or vaporization of the mixture. Iodine can be regenerated by the decomposition of hydriodic acid under anoxic conditions to produce hydrogen and iodine, or in the presence of oxygen to produce iodine and water.

In another embodiment, a method is provided for removing hydrogen sulfide from a gas or liquid stream containing hydrogen sulfide, the method comprises providing at least one reactive absorber reactor comprising a mixture of hydriodic acid, water and regenerable iodine, and reacting hydrogen sulfide in the gas stream with iodine to produce hydriodic acid and sulfur dioxide or elemental sulfur according to the reactor conditions. The hydriodic acid can be decomposed under anoxic conditions to produce hydrogen and iodine or in the presence of oxygen to produce iodine and water. The method can further optionally comprise processing the hydrogen, sulfur dioxide and other impurities in at least one secondary purification unit to separate out the hydrogen from sulfur dioxide and other impurities. When the elemental sulfur is produced, it can be removed using solid separation methodologies, such as filters.

### BRIEF DESCRIPTION OF THE DRAWINGS

For a better understanding of the present disclosure, reference is made to the drawing below, in which like elements are referenced with like numerals, and in which:

FIG. 1 is an example diagram of a system for producing hydrogen and sulfur dioxide in a system that cycles between two hydrogen sulfide removal reactors with secondary separation units for processing impurities and recovering hydrogen. Additional separation units may be placed in series with the unit shown in FIG. 1.

FIG. 2 is an example embodiment of a system that produces elemental sulfur and water using a single reactor without secondary separation units.

FIG. 3 is an example embodiment of a cyclic system with the two reaction steps (reactive absorption and the hydriodic acid decomposition) separated into distinct reactors with secondary separation units for hydrogen purification.

### DETAILED DESCRIPTION

The present disclosure describes hydrogen sulfide removal systems that use the reactivity of iodine with hydrogen sulfide to remove hydrogen sulfide from a gas or liquid stream and the instability of the hydriodic acid product of this reaction to regenerate the iodine under thermal, photonic, catalyzed, or other conditions. The system utilizes one or more reactive absorber reactors containing a mixture of hydriodic acid, water and iodine, to remove hydrogen sulfide from a gas or liquid stream entering the system through an inlet into the one or more reactive absorber reactors or scrubber(s). In embodiments, the systems and methods of the disclosure are performed under low temperature conditions with liquid mixtures primarily of hydriodic acid, water and iodine. A low temperature condition as defined herein is a temperature where the absorption solution is maintained as a liquid and does not boil or vaporize.

The method is carried out with two primary reaction steps, 1) the production of hydriodic acid by the reaction of hydrogen sulfide with iodine (producing either sulfur dioxide or elemental sulfur according to the reactor conditions), which is balanced by 2) the continuous decomposition of hydriodic acid either anoxically producing hydrogen gas or with the introduction of oxygen producing water. In embodiments, the introduction of oxygen can be provided using air at ambient temperature. The two primary reaction steps occur across one or more hydrogen sulfide removal reactors (alternatively referred to as scrubber reactor in the figures). In some embodiments, the reactor is configured with an inlet that can cycle the hydrogen sulfide containing gas or liquid stream between more than one hydrogen sulfide removal reactors to maintain continuous absorption of reaction products (such as, hydrogen, sulfur dioxide, elemental sulfur). To achieve continuous absorption, more than one reactive absorber reactors can be positioned in parallel or in series with valves and piping that can direct the hydrogen sulfide containing gas or fluid to the desired reactor.

In some configurations of the system, at least one secondary purification unit can be placed after the hydrogen sulfide removal system or reactors to separate out the hydrogen or sulfur dioxide from the gas stream.

In other configurations of the system, at least one secondary purification unit can be used to remove sulfur from the absorption solution. As described herein, the “absorption solution” is the liquid reactants in the reactive absorber(s), e.g., iodine, water and hydriodic acid, such as an azeotropic mixture of these.

The reactor where the hydriodic acid is decomposed (in the scrubber or in a separate decomposition reactor) can either be operated anoxically to produce hydrogen and iodine or with oxygen present to produce iodine and water. When the process is anoxic, the decomposition rate of hydriodic acid can be increased by raising the temperature of the reactor, for example to near the solution's boiling point. Alternatively, the solution can be subjected to UV light to increase the rate of decomposition.

In embodiments, the instability of the hydriodic acid product of this reaction leading to the regeneration of iodine can be augmented using thermal, photonic, catalyzed, electrolyzed or other conditions. Under photonic conditions, the scrubber or the decomposition reactor can use incident UV light through a window or other transparent surface to increase the reaction rate of hydriodic acid decomposition. Under thermal conditions, the scrubber or decomposition reactor can use external or internal heat sources to raise the temperature and thus increase the decomposition rate of hydriodic acid. The temperature of the solution can be raised to near its boiling point, but not boiling. For catalyzed reactions, the presence of catalysts either perpetually fixed in the scrubber or decomposition reactor or inserted during hydriodic acid decomposition will increase the reaction rate of hydriodic acid decomposition. Activated carbon is an example of a catalyst with activity for this decomposition reaction. For electrolyzed reactions, hydriodic acid can be decomposed into iodine using electricity and electrodes through electrochemical reactions.

The gas or liquid stream free of hydrogen sulfide (sweetened gas or liquid) exiting the one or more hydrogen sulfide removal reactors can be collected and the reaction products optionally recovered or purified.

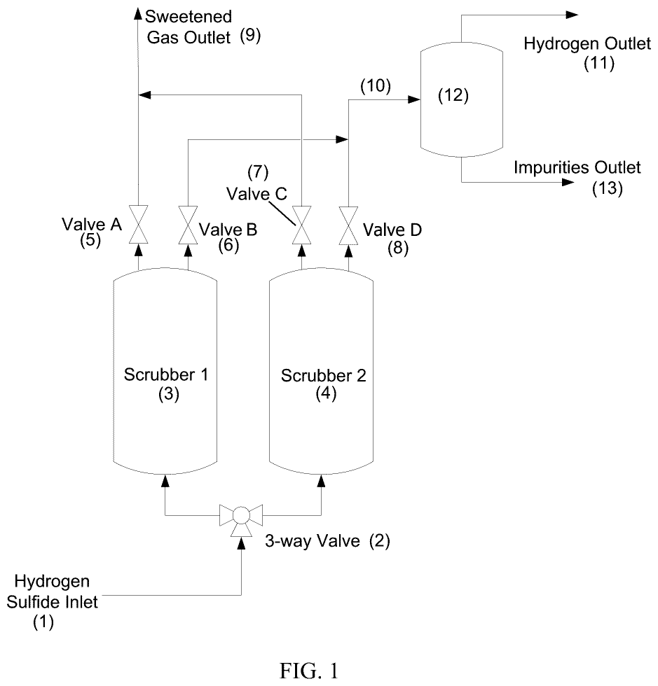

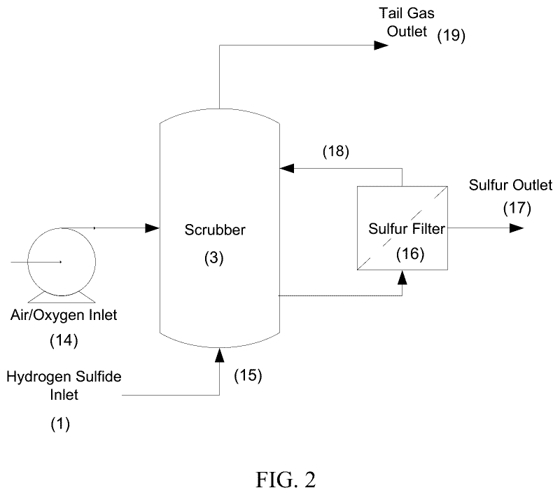

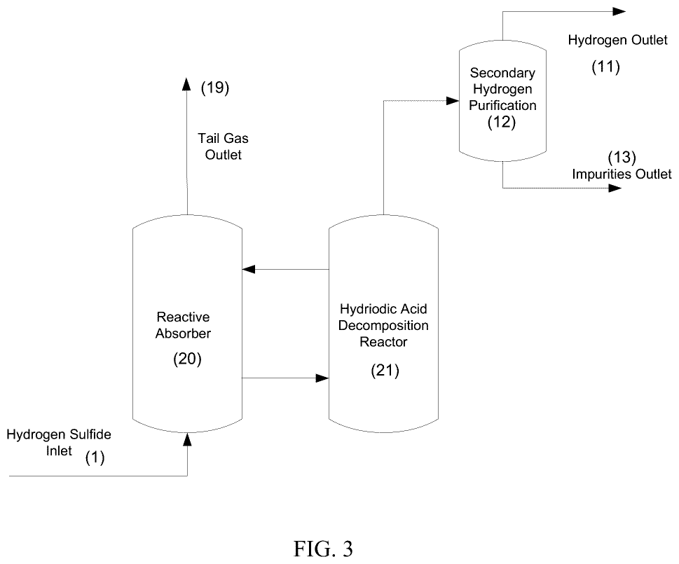

The systems of the disclosure are comprised of the following elements: a reactive absorber (also referred to herein as a scrubber), a reactor for sulfur removal, and a reactor for hydriodic acid decomposition/iodine regeneration. These elements of the process may occur in the same reactor (see FIGS. 1 and 2), either acting simultaneously or performed in series. In other embodiments, these elements may also occur in distinct vessels. See FIG. 3 which illustrates a separate reactive absorber and decomposition reactor. In some embodiments, one or more hydrogen sulfide removal reactors can be arranged in parallel or in series. The number of hydrogen sulfide removal reactors can be 2, 3, 4, 5, 6, 7, 8, 9, 10, 11, 12 or more. The number of hydrogen sulfide removal reactors will depend on factors such as, but not limited to, system footprint, volume of liquid mixture required, volume of gas or liquid containing the hydrogen sulfide to be processed, size of the individual reactors, and the degree of hydrogen sulfide removal required by the process. Additional separation units (also referred to herein as secondary purification unit(s)) may also be included to purify outlet streams. In embodiments, at least two purification units are placed in series.

In an embodiment, the reactive absorber is a piece of equipment that facilitates the contact between the hydrogen sulfide in the incoming gas inlet and the iodine present in the liquid mixture. Depending on the phase and concentration of the reactants, the system will either produce elemental sulfur (at high concentrations of hydrogen sulfide and when iodine is present as a solid or solid slurry, Equation 1) or solvated sulfur dioxide (at low concentrations of hydrogen sulfide or when iodine is well solvated, for example with hydriodic acid, Equation 2). In either case, the iodine reactant is reduced to hydriodic acid. This reactive absorber can take the form of a tray column, a packed column, a bubble column, or other equipment allowing the contact of gas and liquid phases.

$${H}_{2} S + {I}_{2} \to {S}^{o} + 2 HI \qquad Equation 1$$

$${H}_{2} S + 3 {I}_{2} + 2 {H}_{2} O \to 6 HI + {SO}_{2} \qquad Equation 2$$

In the case that elemental and colloidal sulfur is formed in the reactive absorber, this solid must be continuously or periodically removed from the liquid phase. This could be accomplished by a simple filter either in planar or rotary geometries. It could also be accomplished by flocculation prior to filtration. Other known solid separation methodologies can be used to remove elemental sulfur from the liquid phase, such as but not limited to sedimentation and decanting, centrifugation, or a reactive separation.

In the case that dissolved sulfur dioxide is formed, it can be removed with the tail gas (which occurs naturally after a sufficient concentration has been achieved in the liquid phase), or it can be removed in batch systems by degassing. This sulfur dioxide degassing can be accomplished by temperature swings (for example, heating the liquid to near its boiling point) or pressure swings.

Iodine regeneration can be accomplished in two ways. First, oxygen will react with hydriodic acid to produce water and iodine (Equation 3). Thus, a simple method of regenerating iodine is to allow contact of the hydriodic acid solution and oxygen (for example in ambient air).

$$2 HI + \frac{1}{2} {O}_{2} \to {H}_{2} O + {I}_{2} \qquad Equation 3$$

However, hydriodic acid, even in the absence of oxygen, will slowly decompose to iodine and hydrogen (Equation 4).

$$2 HI \to {H}_{2} + {I}_{2} \qquad Equation 4$$

This method produces a favorable product in the form of hydrogen gas, but is slower with a far lower equilibrium concentration of iodine compared to the reaction with oxygen. The speed of this anoxic reaction can be increased by raising the temperature (for example to near the solution's boiling point) or subjecting the fluid to UV light or activated by electricity and electrodes through electrochemical reactions. The presence of catalysts, for example activated carbon, also will increase the decomposition rate.

These three processing elements, 1) reactive absorption, 2) sulfur removal, and 3) iodine regeneration, can be combined in a number of different ways. For example, these processing elements can be arranged in a continuous system with separate reactors for reactive absorption and hydriodic acid decomposition with pumps moving the fluid between reactors (see FIG. 3). They can also be arranged in a batch process, where a reactive absorber can be intermittently used and then regenerated between batches (see FIG. 2). Hybrids of these methods could use the same reactor for reactive absorption and hydriodic acid decomposition but achieve continuous or semi-continuous operation by switching the inlet between multiple reactors (see FIG. 1).

Referring to the figures, FIG. 1 illustrates an example system for removing hydrogen sulfide from a gas or liquid stream containing hydrogen sulfide. In operation, the gas or liquid stream containing hydrogen sulfide (1) can enter one or both reaction vessels (3) and (4) arranged in parallel (shown in the figure as “scrubbers”) via piping and a three-way valve (2). The reactions vessels contain a mixture of hydriodic acid, water and iodine. Each reaction vessel comprises a valved outlet (5), (7) for the sweetened gas to exit and be collected (9), and another valved outlet (6), (8) for collection of hydrogen gas, sulfur dioxide and other impurities to exit (10), for optional further processing. In one use of the system of FIG. 1, both reactors can process the gas or liquid in parallel, such as for batch processing. In an alternative use of the system, the reaction can be cycled between the two hydrogen sulfide removal reactors for continuous processing. The system produces hydrogen and sulfur dioxide, which can be delivered to a secondary separation unit (12) for processing impurities (13) and recovering hydrogen (11). As shown, FIG. 1 has a secondary separation unit (12) where hydrogen gas can be purified, collected, and separated from other impurities. In an embodiment not shown in FIG. 1, additional separation units can be added to the system design, and/or additional reaction vessels in parallel. The reaction conditions for the system configuration of FIG. 1 are as follows:

A pressure of between 0.5 bars and 40 bars, expected to typically operate near 1 bar or 1.5 bars;

A temperature of between about-5 degrees Celsius and about 160 degrees Celsius, expected to typically operate near about 25 degrees Celsius.

A liquid composition of the reactor comprises:

Between about 20 wgt % and about 60 wgt % hydriodic acid, for example about 50% wgt %;

Between about 25 wgt % and about 70 wgt % water, for example about 45% wgt %; and

Between about 1 wgt % and about 20 wgt % iodine, for example about 5% wgt %;

Between about 0 wgt % and 10 wgt % sulfur products, either elemental sulfur or, in the case of the system described in FIG. 1, sulfur dioxide.

FIG. 1 also illustrates the use of the reaction vessel for regeneration of the reaction solution, namely regeneration of iodine under anoxic conditions. The reaction vessel serves the dual purpose of reactive absorption and hydriodic acid decomposition. In one embodiment, one reactor can be processing hydrogen sulfide while the other reactor is regenerating iodide, to provide a continuously operating system.

FIG. 2 illustrates an example system that produces elemental sulfur and water using a single scrubber reactor (3) without secondary separation unit(s). In operation, the system of FIG. 2 is used for removing hydrogen sulfide from a gas or liquid stream containing hydrogen sulfide (1) and collecting the gas or liquid stream via a tail gas outlet (19). The gas or liquid stream containing hydrogen sulfide enters through an inlet (15) into the reaction vessel (3) containing a mixture of hydriodic acid, water and iodine. As the reaction proceeds, elemental sulfur is produced and needs to be continuously removed from the system via a sulfur filter unit (16). Elemental sulfur exiting the filter unit outlet (17) can be collected, used or discarded. Liquid that passes through the filter unit free of sulfur is allowed to reenter the reactor vessel (18). Also illustrated in FIG. 2 is an inlet for oxygen or air (14) into the reaction vessel (3) for regenerating iodine in the reaction vessel by the decomposition of hydriodic acid. The reactor vessel serves the dual purpose of reactive absorption and hydriodic acid decomposition. When the reactor is used in the regeneration mode, the flow of the gas or liquid stream containing hydrogen sulfide into the reactor is stopped and the oxygen or air is allowed to enter the reactor for a period of time sufficient to decompose the hydriodic acid into iodine to a concentration that is about the level of the start-up mixture.

FIG. 3 illustrates an example embodiment of a cyclic system with the two reaction steps, namely for reactive absorption and hydriodic acid decomposition, separated into distinct reactors (20), (21). In operation, the system of FIG. 3 is used for removing hydrogen sulfide from a gas or liquid stream containing hydrogen sulfide. The gas or liquid stream containing hydrogen sulfide enters through an inlet (1) into the reaction vessel (20) containing a mixture of hydriodic acid, water and iodine. Processed gas or liquid with hydrogen sulfide removed can be collected through a tail gas outlet (19) on the reactive absorber vessel (20). The system produces hydrogen and sulfur dioxide, which is delivered to a hydriodic acid decomposition reaction by a pump, for example. The decomposition reactor (21) will decompose hydriodic acid into iodine and the regenerated iodine delivered back to the reactive absorber vessel (20). In various embodiments, decomposition can be augmented by using thermal, photonic, catalyzed, or other conditions, as described herein.

As shown, FIG. 3 has a secondary separation unit (12) where hydrogen gas can be purified, collected and separated from other impurities (hydrogen outlet 11, impurities outlet 13). In an embodiment not shown in FIG. 3, additional separation units can be added to the system design, and/or additional reaction vessels in parallel or in series. The reaction conditions (concentration, flow rates and residence times) for the system configuration of FIG. 3 are typically the same as used in the system of FIG. 1.

The variations in the design and arrangement of the three processing elements are in addition to the choice of reactor conditions which will decide the form of sulfur product and choice of iodine regeneration method. Several possible variations will be described below.

In one variation, a sour natural gas can comprise the following components:

Between about 500 ppm and about 10 vol % hydrogen sulfide, for example about 2 vol %;

Between about 60 vol % and about 90 vol % methane, for example about 75 vol %;

Between about 1 vol % and about 15 vol % ethane, for example about 8 vol %;

Between about 1 vol % and about 10 vol % nitrogen, for example about 5 vol %;

Between about 1 vol % and about 10 vol % carbon dioxide, for example about 5 vol %;

Between about 1 vol % and about 10 vol % propane, for example about 2.5 vol %;

Between about 1 vol % and about 5 vol % butane, for example about 2.5 vol %;

Between about 1 vol % and about 5 vol % heavier hydrocarbons (pentane, hexane, etc.) for example about 2.5 vol %; and

Between about 0 vol % and about 2.5 vol % additional impurities including at least one of helium, hydrogen, neon, water vapor, and other minor components.

The sour natural gas of this variation enters the reactor through the inlet and is bubbled at a rate of about 10 MSCFD (thousand standard cubic feet per day) through a 120-gallon tank filled with a slurry of iodine (75 kg), hydriodic acid (50 kg azeotropic mixture), and water (50 kg) (see FIG. 2, SCRUBBER). The hydrogen sulfide reacts with the iodine slurry to produce hydriodic acid and elemental sulfur. After about 1 hour, the hydrogen sulfide has consumed the iodine in the reactor leaving behind solid elemental sulfur. The sour natural gas inlet is stopped and the scrubber is regenerated by (1) pumping the liquid through a filter that removes the solid agglomerated sulfur and (2) flowing air through the scrubber at a flow rate of 100 MSCFD, regenerating iodine from hydriodic acid. After about 2 hours, the tank is at approximately its starting composition and additional sour natural gas can be fed to the system, starting the cycle over again.

In another variation, sour natural gas can comprise the following components:

Between about 5 vol % and about 99 vol % hydrogen sulfide, for example about 80 vol %;

Between about 0 vol % and about 2 vol % methane, for example about 0 vol %;

Between about 1 vol % and about 10 vol % nitrogen, for example about 5 vol %;

Between about 1 vol % and about 50 vol % carbon dioxide, for example about 15 vol %; and

Between about 0 vol % and about 5 vol % additional impurities including at least one of mercaptans, noble gases, amines, water vapor, and other minor components.

In this variation, the sour natural gas inlet switches between two 500 gallon tanks (see FIG. 1, SCRUBBER1 and SCRUBBER2). Each scrubber begins with a composition comprising:

Between about 35 wgt % and about 60 wgt % hydriodic acid, for example about 50 wgt %;

Between about 25 wgt % and about 50 wgt % water, for example about 45 wgt %; and

Between about 1 wgt % and about 15 wgt % iodine, for example about 5 wgt %;

The sour gas stream is bubbled through at a rate of about 200 MSCFD will have the iodine content react with the hydrogen sulfide to produce hydriodic acid and solvated sulfur dioxide. After about 3 hours of operation, the sour gas inlet is switched from the freshly depleted scrubber (for example SCRUBBER1) to the regenerated scrubber (for example SCRUBBER2). The freshly depleted scrubber is then regenerated by raising the temperature of scrubber to about 200 deg F and exposing the liquid to direct sunlight. In the headspace above the liquid, hydrogen will form as hydriodic acid spontaneously decomposes into hydrogen and iodine. This reaction both produces a hydrogen product stream (at a flow rate of about about 1 MSFCD) and regenerates the liquid in the scrubber. Once equilibrium is reached (after about 1.5 hours), about 5 kg of water is added to the scrubber. After SCRUBBER2 is depleted, the sour gas stream is switched back to the newly regenerated SCRUBBER1 and the cycle begins again.

### Definitions

It is to be understood that the terminology used herein is for describing particular embodiments only and is not intended to be limiting. Unless defined otherwise, all technical and scientific terms used herein have the same meaning as commonly understood by one of ordinary skill in the art to which the disclosure pertains.

Although any methods and materials similar or equivalent to those described herein may be used in the practice for testing of the present disclosure, exemplary materials and methods are described herein.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C.”

As used in this specification and the appended claims, the singular forms “a,” “an,” and “the” include plural referents unless the content clearly dictates otherwise. The conjunctive term “and/or” between multiple recited elements is understood as encompassing both individual and combined options. For instance, where two elements are conjoined by “and/or,” a first option refers to the applicability of the first element without the second. A second option refers to the applicability of the second element without the first. A third option refers to the applicability of the first and second elements together. Any one of these options is understood to fall within the meaning, and therefore satisfy the requirement of the term “and/or” as used herein. Concurrent applicability of more than one of the options is also understood to fall within the meaning, and therefore satisfy the requirement of the term “and/or.”

Unless the context requires otherwise, throughout the specification and claims that follow, the word “comprise” and synonyms and variants thereof such as “have” and “include”, as well as variations thereof, such as “comprises” and “comprising”, are to be construed in an open, inclusive sense, e.g., “including, but not limited to.” The transitional terms “comprising,” “consisting essentially of,” and “consisting of” are intended to connote their generally accepted meanings in the patent vernacular; that is, (i) “comprising,” which is synonymous with “including,” “containing,” or “characterized by,” is inclusive or open-ended and does not exclude additional, unrecited elements or method steps; (ii) “consisting of” excludes any element or step not specified in the claim; and (iii) “consisting essentially of” limits the scope of a claim to the specified materials or steps “and those that do not materially affect the basic and novel characteristic(s)” of the claimed invention. Embodiments described in terms of the phrase “comprising” (or its equivalents) also provide as embodiments those independently described in terms of “consisting of” and “consisting essentially of.”

“About” means within an acceptable error range for the particular value as determined by one of ordinary skill in the art, which will depend in part on how the value is measured or determined, i.e., the limitations of the measurement system. Unless explicitly stated otherwise within the disclosure, claims, result or embodiment, “about” means within one standard deviation per the practice in the art, or can mean a range of ±20%, ±10%, ±5%, ±4, ±3, ±2 or ±1% of a given value. It is to be understood that the term “about” can precede any particular value specified herein, except for particular values used in the Examples. For example, an “about” azeotropic mixture of hydriodic acid and water will include 57% by weight (±10%).

All percents are intended to be weight percent unless otherwise specified. The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method for removing hydrogen sulfide from a gas or liquid stream containing hydrogen sulfide, comprising reacting the hydrogen sulfide in the gas or liquid stream in a reactor with a mixture of iodine, water, and hydriodic acid, under conditions below the boiling point or vaporization of the mixture, to thereby remove the hydrogen sulfide; and
then regenerating the iodine in the liquid phase, under conditions below the boiling point or vaporization of the mixture.

2. The method of claim 1, wherein the hydrogen sulfide is oxidized to elemental sulfur by an iodine slurry and removed via solid separation methodologies.

3. The method of claim 1, wherein the hydrogen sulfide is oxidized to sulfur dioxide and hydrogen by a dilute mixture of iodine solvated by concentrated hydriodic acid.

4. The method of claim 2, wherein the solid separation is accomplished by filtration in rotary or planar geometries.

5. The method of claim 3, wherein the sulfur dioxide is degassed by temperature or pressure-swing.

6. The method of claim 3, wherein the hydrogen product stream is purified with pressure swing adsorption methods or by chemical scrubbing.

7. A method for removing hydrogen sulfide from a gas or liquid stream containing hydrogen sulfide, comprising:
providing at least one reactive absorber reactor comprising a mixture of hydriodic acid, water and regenerable iodine, and reacting hydrogen sulfide in the gas or liquid stream with iodine to produce hydriodic acid and sulfur dioxide or elemental sulfur according to the reactor conditions;
decomposing the hydriodic acid under anoxic conditions to produce hydrogen and iodine or in the presence of oxygen to produce iodine and water; and
optionally, processing hydrogen and sulfur dioxide in at least one secondary purification unit to separate the hydrogen from the sulfur dioxide,
wherein the hydrogen sulfide is removed from the gas stream.

8. The method of claim 7, wherein the reactive absorber is in the form of a tray column, a packed column, a bubble column.

9. The method of claim 7, wherein when the hydriodic acid is anoxically decomposed, the rate of the anoxic reaction can be increased by raising the temperature (for example to near the solution's boiling point) or subjecting the solution to UV light or subjecting the solution to electricity through electrochemical reactions.

10. The method of claim 7, wherein when the hydriodic acid is anoxically decomposed, the rate of anoxic reaction can be increased in the presence of a catalyst, for example activated carbon.

11. The method of claim 7, wherein the method is performed in batch mode, continuous mode or semi-continuous mode.

12. The method of claim 7, wherein when more than one reactive absorber reactor is present, they are arranged in parallel or in series.

13. The method of claim 7, wherein the decomposition process occurs in the presence of ambient air.

14. The method of claim 7, wherein when elemental sulfur is produced, it is removed via solid separation methodologies.
